(19) United States
(12) Patent Application Publication
(10) Pub. No.: US 2023/0336789 A1
(43) Pub. Date: Oct. 19, 2023

(54) METHOD FOR DECODING IMMERSIVE VIDEO AND METHOD FOR ENCODING IMMERSIVE VIDEO

(71) Applicant: Electronics and Telecommunications Research Institute, Daejeon (KR)

(72) Inventors: Kwan Jung OH, Daejeon (KR); Gwang Soon LEE, Daejeon (KR); Hong Chang SHIN, Daejeon (KR); Jun Young JEONG, Daejeon (KR); Jeong Il SEO, Daejeon (KR); Jae Gon KIM, Goyang-si (KR); Sung Gyun LIM, Goyang-si (KR); Hyeon Jong HWANG, Seoul (KR)

(73) Assignee: Electronics and Telecommunications Research Institute, Daejeon (KR)

(21) Appl. No.: 18/302,631

(22) Filed: Apr. 18, 2023

(30) Foreign Application Priority Data
Apr. 19, 2022 (KR) 10-2022-0048525
Jul. 12, 2022 (KR) 10-2022-0085700

(51) Int. Cl. H04N 19/85; H04N 19/176; H04N 19/136; H04N 19/80

(52) U.S. Cl. CPC H04N 19/85; H04N 19/176; H04N 19/136; H04N 19/80

(57) ABSTRACT

An immersive image encoding method according to the present disclosure includes classifying a plurality of view images into a basic image and an additional image; performing pruning for at least one of the plurality of view images based on the classification result; generating a depth atlas based on a result of performing the pruning; and correcting an occupancy state of pixels in the depth atlas.

### FIELD OF INVENTION

The present disclosure relates to a method for encoding/decoding an immersive video which supports motion parallax for a rotation and translation motion.

### BACKGROUND OF THE INVENTION

A virtual reality service is evolving in a direction of providing a service in which a sense of immersion and realism are maximized by generating an omnidirectional image in a form of an actual image or CG (Computer Graphics) and playing it on HMD, a smartphone, etc. Currently, it is known that 6 Degrees of Freedom (DoF) should be supported to play a natural and immersive omnidirectional image through HMD. For a 6DoF image, an image which is free in six directions including (1) left and right rotation, (2) top and bottom rotation, (3) left and right movement, (4) top and bottom movement, etc. should be provided through a HMD screen. But, most of the omnidirectional images based on an actual image support only rotary motion. Accordingly, a study on a field such as acquisition, reproduction technology, etc. of a 6DoF omnidirectional image is actively under way.

### DISCLOSURE

### Technical Problem

The present disclosure is to provide a method for correcting an occupancy state judgment error of each pixel in a depth atlas.

The present disclosure is to reduce a size of a guard band by correcting an occupancy state judgment error.

The technical objects to be achieved by the present disclosure are not limited to the above-described technical objects, and other technical objects which are not described herein will be clearly understood by those skilled in the pertinent art from the following description.

### Technical Solution

An immersive image encoding method according to the present disclosure includes classifying a plurality of view images into a basic image and an additional image; performing pruning for at least one of the plurality of view images based on the classification result; generating a depth atlas based on a result of performing the pruning; and correcting an occupancy state of pixels in the depth atlas.

An immersive image decoding method according to the present disclosure includes receiving a bitstream; decoding a depth atlas from the bitstream; and correcting an occupancy state of pixels in the depth atlas.

In an immersive image encoding/decoding method according to the present disclosure, based on a dominant state in a block, the correction may be performed and the dominant state may be determined by comparing the number of valid pixels with the number of invalid pixels in the block.

In an immersive image encoding/decoding method according to the present disclosure, the correction may be performed by applying a central value filter in a block.

In an immersive image encoding/decoding method according to the present disclosure, the correction may be performed by applying an average filter in a block.

In an immersive image encoding/decoding method according to the present disclosure, the correction may be a change of a value of the current pixel into one of the most probable values around a current pixel.

In an immersive image encoding/decoding method according to the present disclosure, the correction may be performed based on one of a plurality of correction method candidates and information indicating one of the plurality of correction method candidates may be encoded and signaled.

In an immersive image encoding/decoding method according to the present disclosure, an occupancy state of a pixel may be determined by comparing a pixel value with a first threshold value, and the correction may be performed only when a difference between the pixel value and the first threshold value is smaller than a second threshold value.

The technical objects to be achieved by the present disclosure are not limited to the above-described technical objects, and other technical objects which are not described herein will be clearly understood by those skilled in the pertinent art from the following description.

### Technical Effects

According to the present disclosure, quality of a viewport image may be improved by correcting an occupancy state judgment error of each pixel in a depth atlas.

According to the present disclosure, the present disclosure may improve quality of a viewport image by correcting an occupancy state judgment error and reducing a size of a guard band.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a block diagram of an immersive video processing device according to an embodiment of the present disclosure.

FIG. 2 is a block diagram of an immersive video output device according to an embodiment of the present disclosure.

FIG. 3 is a flow chart of an immersive video processing method.

FIG. 4 is a flow chart of an atlas encoding process.

FIG. 5 is a flow chart of an immersive video output method.

FIG. 6 represents an example in which an occupancy state is corrected in a unit of a block.

FIG. 7 represents the number of blocks that an error per sequence occurs and the number of blocks that correction may not be performed by a proposed error correction method according to a value of threshold value T.

FIG. 8 compares a viewport image according to whether an occupancy state correction method is applied.

FIG. 9 represents a syntax structure including information related to occupancy state correction.

FIG. 10 represents a reconstructed depth value histogram after atlas encoding and decoding.

### DETAILED EMBODIMENTS

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive video, when a user's watching position is changed, refers to an image that a viewport may be also dynamically changed. In order to implement an immersive video, a plurality of input images are required. Each of a plurality of input images may be referred to as a source image or a view image. A different view index may be assigned to each view image.

An immersive video may be classified into 3DoF (Degree of Freedom), 3DoF+, Windowed-6DoF or 6DoF type, etc. A 3DoF-based immersive video may be implemented by using only a texture image. On the other hand, in order to render an immersive video including depth information such as 3DoF+ or 6DoF, etc., a depth image (or, a depth map) as well as a texture image is also required.

It is assumed that embodiments described below are for immersive video processing including depth information such as 3DoF+ and/or 6DoF, etc. In addition, it is assumed that a view image is configured with a texture image and a depth image.

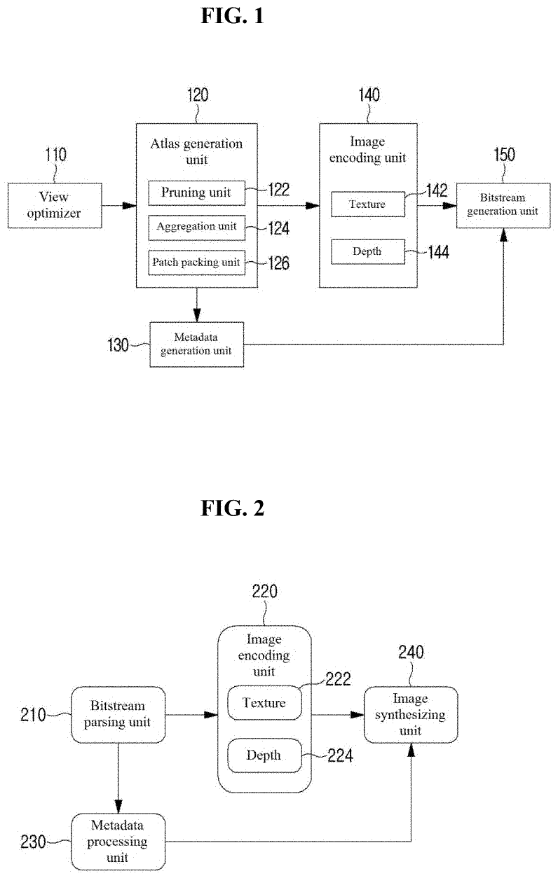

FIG. 1 is a block diagram of an immersive video processing device according to an embodiment of the present disclosure.

In reference to FIG. 1, an immersive video processing device according to the present disclosure may include a view optimizer 110, an atlas generation unit 120, a metadata generation unit 130, an image encoding unit 140 and a bitstream generation unit 150.

An immersive video processing device receives a plurality of pairs of images, a camera internal variable and a camera external variable as an input value to encode an immersive video. Here, a plurality of pairs of images include a texture image (Attribute component) and a depth image (Geometry component). Each pair may have a different view. Accordingly, a pair of input images may be referred to as a view image. Each of view images may be divided by an index. In this case, an index assigned to each view image may be referred to as a view or a view index.

A camera internal variable includes a focal distance, a position of a principal point, etc. and a camera external variable includes a position, a direction, etc. of a camera. A camera internal variable and a camera external variable may be treated as a camera parameter or a view parameter.

A view optimizer 110 partitions view images into a plurality of groups. As view images are partitioned into a plurality of groups, independent encoding processing per each group may be performed. In an example, view images filmed by N spatially consecutive cameras may be classified into one group. Thereby, view images that depth information is relatively coherent may be put in one group and accordingly, rendering quality may be improved.

In addition, by removing dependence of information between groups, a spatial random access service which performs rendering by selectively bringing only information in a region that a user is watching may be made available.

Whether view images will be partitioned into a plurality of groups may be optional.

In addition, a view optimizer 110 may classify view images into a basic image and an additional image. A basic image represents an image which is not pruned as a view image with a highest pruning priority and an additional image represents a view image with a pruning priority lower than a basic image.

A view optimizer 110 may determine at least one of view images as a basic image. A view image which is not selected as a basic image may be classified as an additional image.

A view optimizer 110 may determine a basic image by considering a view position of a view image. In an example, a view image whose view position is the center among a plurality of view images may be selected as a basic image.

Alternatively, a view optimizer 110 may select a basic image based on a camera parameter. Specifically, a view optimizer 110 may select a basic image based on at least one of a camera index, a priority between cameras, a position of a camera or whether it is a camera in a region of interest.

In an example, at least one of a view image with a smallest camera index, a view image with a largest camera index, a view image with the same camera index as a predefined value, a view image filmed by a camera with a highest priority, a view image filmed by a camera with a lowest priority, a view image filmed by a camera at a predefined position (e.g., a central position) or a view image filmed by a camera in a region of interest may be determined as a basic image.

Alternatively, a view optimizer 110 may determine a basic image based on quality of view images. In an example, a view image with highest quality among view images may be determined as a basic image.

Alternatively, a view optimizer 110 may determine a basic image by considering an overlapping data rate of other view images after inspecting a degree of data redundancy between view images. In an example, a view image with a highest overlapping data rate with other view images or a view image with a lowest overlapping data rate with other view images may be determined as a basic image.

A plurality of view images may be also configured as a basic image.

An Atlas generation unit 120 performs pruning and generates a pruning mask. And, it extracts a patch by using a pruning mask and generates an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124 and a patch packing unit 126.

A pruning unit 122 performs pruning for an additional image based on a pruning priority. Specifically, pruning for an additional image may be performed by using a reference image with a higher pruning priority than an additional image.

A reference image includes a basic image. In addition, according to a pruning priority of an additional image, a reference image may further include other additional image.

Whether an additional image may be used as a reference image may be selectively determined. In an example, when an additional image is configured not to be used as a reference image, only a basic image may be configured as a reference image.

On the other hand, when an additional image is configured to be used as a reference image, a basic image and other additional image with a higher pruning priority than an additional image may be configured as a reference image.

Through a pruning process, redundant data between an additional image and a reference image may be removed. Specifically, through a warping process based on a depth image, data overlapped with a reference image may be removed in an additional image. In an example, when a depth value between an additional image and a reference image is compared and that difference is equal to or less than a threshold value, it may be determined that a corresponding pixel is redundant data.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

While a non-overlapping region may have a non-square shape, a patch is limited to a square shape. Accordingly, a patch may include an invalid region as well as a valid region. Here, a valid region refers to a region composed of non-overlapping pixels between an additional image and a reference image. In other words, a valid region represents a region that includes data which is included in an additional image, but is not included in a reference image. An invalid region refers to a region composed of overlapping pixels between an additional image and a reference image. A pixel/data included by a valid region may be referred to as a valid pixel/valid data and a pixel/data included by an invalid region may be referred to as an invalid pixel/invalid data.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of a shape of a valid region, a patch is extracted in a square shape, so a patch extracted from a square valid region may include invalid data as well as valid data.

In this case, an aggregation unit 124 may repartition a L-shaped or C-shaped patch which reduces encoding efficiency. Here, a L-shaped patch represents that distribution of a valid region is L-shaped and a C-shaped patch represents that distribution of a valid region is C-shaped.

When distribution of a valid region is L-shaped or C-shaped, a region occupied by an invalid region in a patch is relatively large. Accordingly, a L-shaped or C-shaped patch may be partitioned into a plurality of patches to improve encoding efficiency.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map or a Perspective Projection Format.

Here, an unpruned view image refers to a basic image with a highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 packs a patch in a square image. In patch packing, deformation such as size transform, rotation, or flip, etc. of a patch may be accompanied. An image that patches are packed may be defined as an atlas.

Specifically, a packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of an arrangement structure of a camera rig, accuracy of a depth map or the number of view images.

A metadata generation unit 130 generates metadata for image synthesis. Metadata may include at least one of camera-related data, pruning-related data, atlas-related data or patch-related data.

Pruning-related data includes information for determining a pruning priority between view images. In an example, at least one of a flag representing whether a view image is a root node or a flag representing whether a view image is a leaf node may be encoded. A root node represents a view image with a highest pruning priority (i.e., a basic image) and a leaf node represents a view image with a lowest pruning priority.

When a view image is not a root node, a parent node index may be additionally encoded. A parent node index may represent an image index of a view image, a parent node.

Alternatively, when a view image is not a leaf node, a child node index may be additionally encoded. A child node index may represent an image index of a view image, a child node.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

In an example, geometry_scale_enabled_flag, a syntax representing whether it is allowed to reduce a depth atlas, may be encoded/decoded. When a value of a syntax geometry_scale_enabled_flag is 0, it represents that it is not allowed to reduce a depth atlas. In this case, a depth atlas has the same size as a texture atlas.

When a value of a syntax geometry_scale_enabled_flag is 1, it represents that it is allowed to reduce a depth atlas. In this case, information for determining a reduction ratio of a depth atlas may be additionally encoded/decoded. In an example, geometry_scaling_factor_x, a syntax representing a horizontal directional reduction ratio of a depth atlas, and geometry_scaling_factor_y, a syntax representing a vertical directional reduction ratio of a depth atlas, may be additionally encoded/decoded.

An immersive video output device may restore a reduced depth atlas to its original size after decoding information on a reduction ratio of a depth atlas.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

An image encoding unit 140 encodes an atlas. When view images are classified into a plurality of groups, an atlas may be generated per group. Accordingly, image encoding may be performed independently per group.

An image encoding unit 140 may include a texture image encoding unit 142 encoding a texture atlas and a depth image encoding unit 144 encoding a depth atlas.

A bitstream generation unit 150 generates a bitstream based on encoded image data and metadata. A generated bitstream may be transmitted to an immersive video output device.

FIG. 2 is a block diagram of an immersive video output device according to an embodiment of the present disclosure.

In reference to FIG. 2, an immersive video output device according to the present disclosure may include a bitstream parsing unit 210, an image decoding unit 220, a metadata processing unit 230 and an image synthesizing unit 240.

A bitstream parsing unit 210 parses image data and metadata from a bitstream. Image data may include data of an encoded atlas. When a spatial random access service is supported, only a partial bitstream including a watching position of a user may be received.

An image decoding unit 220 decodes parsed image data. An image decoding unit 220 may include a texture image decoding unit 222 for decoding a texture atlas and a depth image decoding unit 224 for decoding a depth atlas.

A metadata processing unit 230 unformats parsed metadata.

Unformatted metadata may be used to synthesize a specific view image. In an example, when motion information of a user is input to an immersive video output device, a metadata processing unit 230 may determine an atlas necessary for image synthesis and patches necessary for image synthesis and/or a position/a size of the patches in an atlas and others to reproduce a viewport image according to a user's motion.

An image synthesizing unit 240 may dynamically synthesize a viewport image according to a user's motion. Specifically, an image synthesizing unit 240 may extract patches required to synthesize a viewport image from an atlas by using information determined in a metadata processing unit 230 according to a user's motion. Specifically, a viewport image may be generated by extracting patches extracted from an atlas including information of a view image required to synthesize a viewport image and the view image in the atlas and synthesizing extracted patches.

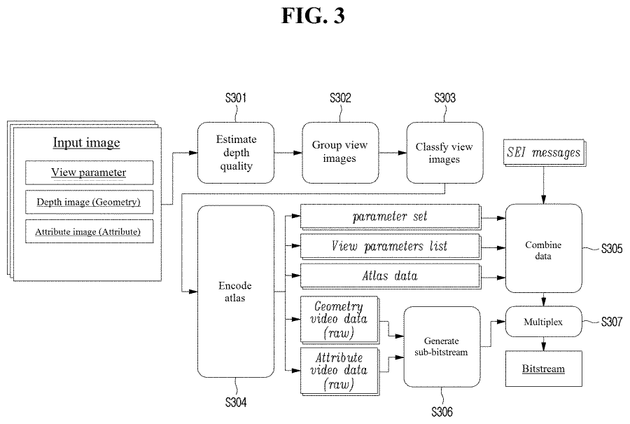

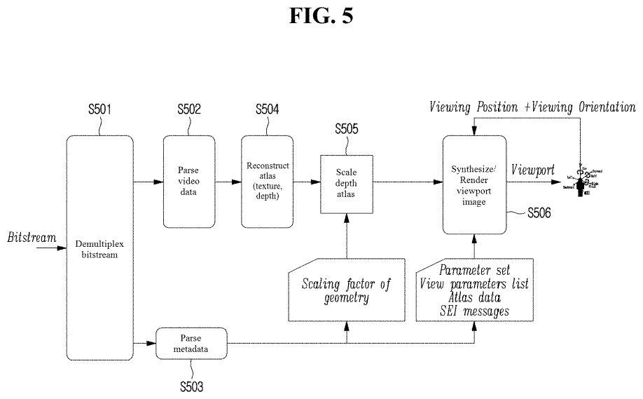

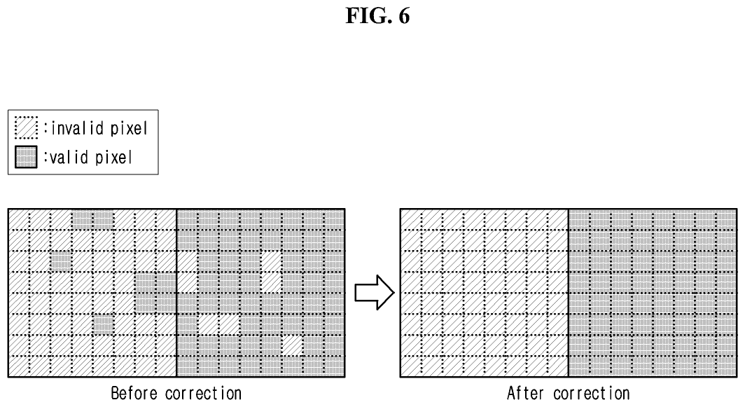

FIGS. 3 and 5 show a flow chart of an immersive video processing method and an immersive video output method, respectively.

In the following flow charts, what is italicized or underlined represents input or output data for performing each step. In addition, in the following flow charts, an arrow represents processing order of each step. In this case, steps without an arrow indicate that temporal order between corresponding steps is not determined or that corresponding steps may be processed in parallel. In addition, it is also possible to process or output an immersive video in order different from that shown in the following flow charts.

An immersive video processing device may receive at least one of a plurality of input images, a camera internal variable and a camera external variable and evaluate depth map quality through input data S301. Here, an input image may be configured with a pair of a texture image (Attribute component) and a depth image (Geometry component).

An immersive video processing device may classify input images into a plurality of groups based on positional proximity of a plurality of cameras S302. By classifying input images into a plurality of groups, pruning and encoding may be performed independently between adjacent cameras whose depth value is relatively coherent. In addition, through the process, a spatial random access service that rendering is performed by using only information of a region a user is watching may be enabled.

But, the above-described S301 and S302 are just an optional procedure and this process is not necessarily performed.

When input images are classified into a plurality of groups, procedures which will be described below may be performed independently per group.

An immersive video processing device may determine a pruning priority of view images S303. Specifically, view images may be classified into a basic image and an additional image and a pruning priority between additional images may be configured.

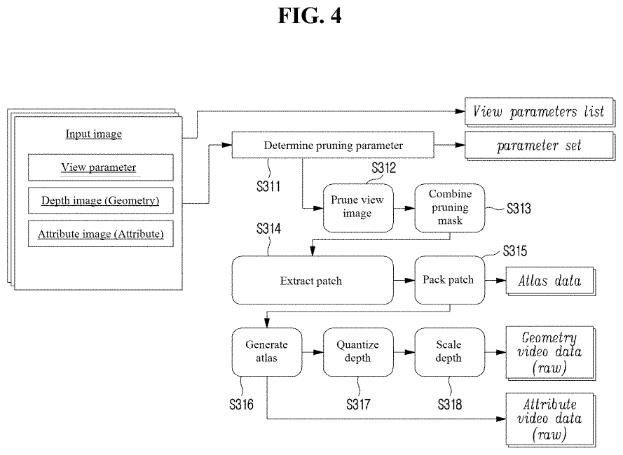

Subsequently, based on a pruning priority, an atlas may be generated and a generated atlas may be encoded S304. A process of encoding atlases is shown in detail in FIG. 4.

Specifically, a pruning parameter (e.g., a pruning priority, etc.) may be determined S311 and based on a determined pruning parameter, pruning may be performed for view images S312. As a result of pruning, a basic image with a highest priority is maintained as it is originally. On the other hand, through pruning for an additional image, overlapping data between an additional image and a reference image is removed. Through a warping process based on a depth image, overlapping data between an additional image and a reference image may be removed.

As a result of pruning, a pruning mask may be generated. If a pruning mask is generated, a pruning mask is combined in a unit of an intra-period S313. And, a patch may be extracted from a texture image and a depth image by using a combined pruning mask S314. Specifically, a combined pruning mask may be masked to texture images and depth images to extract a patch.

In this case, for an unpruned view image (e.g., a basic image), a whole view image may be treated as one patch.

Subsequently, extracted patches may be packed S315 and an atlas may be generated S316. Specifically, a texture atlas and a depth atlas may be generated.

In addition, an immersive video processing device may determine a threshold value for determining whether a pixel is valid or invalid based on a depth atlas S317. In an example, a pixel that a value in an atlas is smaller than a threshold value may correspond to an invalid pixel and a pixel that a value is equal to or greater than a threshold value may correspond to a valid pixel. A threshold value may be determined in a unit of an image or may be determined in a unit of a patch.

For reducing the amount of data, a size of a depth atlas may be reduced by a specific ratio S318. When a size of a depth atlas is reduced, information on a reduction ratio of a depth atlas (e.g., a scaling factor) may be encoded. In an immersive video output device, a reduced depth atlas may be restored to its original size through a scaling factor and a size of a texture atlas.

Metadata generated in an atlas encoding process (e.g., a parameter set, a view parameter list or atlas data, etc.) and SEI (Supplemental Enhancement Information) are combined S305. In addition, a sub bitstream may be generated by encoding a texture atlas and a depth atlas respectively S306. And, a single bitstream may be generated by multiplexing encoded metadata and an encoded atlas S307.

An immersive video output device demultiplexer a bitstream received from an immersive video processing device S501. As a result, video data, i.e., atlas data and metadata may be extracted respectively S502 and S503.

An immersive video output device may restore an atlas based on parsed video data S504. In this case, when a depth atlas is reduced at a specific ratio, a depth atlas may be scaled to its original size by acquiring related information from metadata S505.

When a user's motion occurs, based on metadata, an atlas required to synthesize a viewport image according to a user's motion may be determined and patches included in the atlas may be extracted. A viewport image may be generated and rendered S506. In this case, in order to synthesize generated patches, size/position information of each patch and a camera parameter, etc. may be used.

Information on an occupancy state for judging whether each pixel in a depth atlas is valid may be encoded and signaled.

An occupancy state of a pixel may be embedded in a depth atlas and transmitted. When an occupancy state of a pixel is embedded in a depth atlas, whether a corresponding pixel is valid may be judged based on a depth value of a pixel.

Meanwhile, when occupancy information of a pixel is not embedded in a depth atlas, an occupancy map may be encoded and signaled. Each pixel of an occupancy map represents whether a corresponding pixel in a depth atlas is valid. In an example, when a value of a pixel in an occupancy map is 0, it represents that a pixel of a depth atlas corresponding to a corresponding pixel is not valid. On the other hand, when a value of a pixel in an occupancy map is not 0, it represents that a pixel of a depth atlas corresponding to a corresponding pixel is valid.

Meanwhile, information representing whether an occupancy state is embedded in a depth atlas may be encoded and signaled. The information may be a 1-bit flag. When the flag represents that an occupancy state is embedded in a depth atlas, encoding/decoding of an occupancy map may be omitted. On the other hand, when the flag represents that an occupancy state is not embedded in a depth atlas, an occupancy map for judging an occupancy state of each pixel may be explicitly encoded/decoded.

When an occupancy state is embedded in a depth atlas, validity of a corresponding pixel may be judged based on a pixel value of a depth atlas. In this case, in order to prevent an error in occupancy information which may occur in a process of compressing a depth atlas, a guard band may be configured in a depth dynamic scope. In an example, while a depth value of an invalid pixel is configured as 0, a depth value of a valid pixel may be configured as T or a value greater than T. Accordingly, a scope from 1 to (T−1) may be used as a guard band between an invalid pixel and a valid pixel, and a duration corresponding to a guard band may not be used to encode a valid pixel in a depth atlas.

As a result, a decoder may compare a pixel value of a depth atlas with threshold value T to judge validity of a pixel. Specifically, when a depth value of a pixel is smaller than a threshold value, a corresponding pixel may be judged to be invalid. On the other hand, when a depth value of a pixel is equal to or greater than a threshold value, a corresponding pixel may be judged to be valid. In this case, information on a threshold value may be explicitly encoded and signaled.

When an occupancy state is embedded in a depth atlas and transmitted, a guard band, i.e., information on a threshold value may be explicitly encoded and signaled. The guard band may include a first threshold value which is commonly applied in a depth atlas and a second threshold value which is individually applied in a patch level. In an example, when a threshold value is individually configured for a specific patch, for a corresponding patch, an occupancy state of each pixel is determined by using a second threshold value. On the other hand, when a threshold value is not configured for a specific patch, an occupancy state of each pixel is determined by using a first threshold value.

Meanwhile, as a guard band is larger, an error in an occupancy state judgment decreases. But, as a guard band is larger, there is a problem that a depth scope for encoding/decoding a valid pixel decreases. In order to solve the problem, the present disclosure proposes a method of correcting an error in occupancy information to reduce a scope of a guard band.

A decoder judges an occupancy state of each pixel by comparing a value of a pixel in a depth atlas (i.e., a depth value) with threshold value T after reconstructing a depth atlas. In this case, when an error which occurs in encoding/decoding is greater than guard band T, an occupancy state of some pixels may be wrongly judged. In order to prevent the problem, the present disclosure proposes a method of determining an occupancy state in a unit of a block and correcting an occupancy state in a unit of a block.

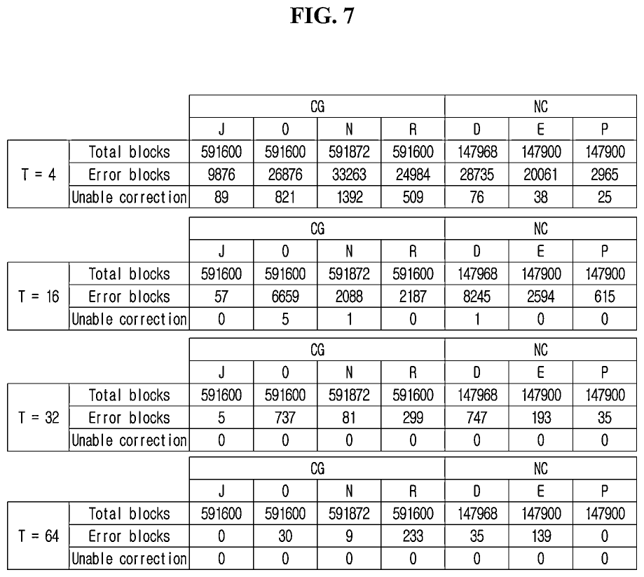

FIG. 6 represents an example in which an occupancy state is corrected in a unit of a block.

A size of a block for correcting an occupancy state may be predefined in an encoder and a decoder. For example, a size of a block may have a size of 4×4, 8×8 or 16×16, etc.

Pixels whose occupancy state in a block is wrongly judged are less likely to be dominant than pixels whose occupancy state is correctly judged. Accordingly, after judging a dominant state in a block, a value of pixels in a block may be transformed into a dominant state to correct an occupancy state of pixels.

Specifically, a dominant state may be determined by comparing the number of valid pixels in a block with the number of invalid pixels. In an example, when the number of valid pixels is greater than the number of invalid pixels, a dominant state may become ‘valid’ and when the number of invalid pixels is greater than the number of valid pixels, a dominant state may become ‘invalid’.

When a dominant state is ‘valid’, invalid pixels in a block may be corrected to valid pixels. On the other hand, when a dominant state is ‘invalid’, valid pixels in a block may be corrected to invalid pixels.

In an example, in an example shown in FIG. 6, it was illustrated that for a left block, valid pixels are corrected to invalid pixels and for a right block, invalid pixels are corrected to valid pixels.

When correcting an invalid pixel to a valid pixel, it may mean that a value of an invalid pixel is changed into the same value as threshold value T or a value greater than threshold value T.

In addition, when correcting a valid pixel to an invalid pixel, it may mean that a value of a valid pixel is changed into a value smaller than threshold value T. In an example, when a value of a valid pixel is corrected to an invalid pixel, a value of a corresponding pixel may be changed into 0.

After correcting a value of a pixel (i.e., a depth value), based on a corrected pixel, an occupancy state may be judged. In an example, a value of pixels and an occupancy state may be corrected by applying a central value filter to a block. When a central value filter is applied, a central value is selected after arranging pixels belonging to an application scope of a central value filter in order of size. Subsequently, a value of a pixel at a position where a central value filter is applied may be substituted with a central value.

A size of a central value filter may be predefined in an encoder and a decoder. Alternatively, according to a size of a block, a size of a central value filter may be determined.

In another example, based on an average filter and rounding off operation, a value of a pixel may be corrected. When an average filter is applied, a value of a pixel at a position where an average filter is applied may be corrected to an average value of pixels to which an average filter is applied. In this case, a size of an average filter may be predefined in an encoder and a decoder.

Alternatively, according to a size of a block, a size of a central value filter may be determined.

Alternatively, a value of all pixels in a block may be corrected to an average value of all pixels in a block.

In another example, based on the most probable value, a value of a pixel may be corrected. In an example, based on a current sample, a value of a current pixel may be corrected to a value of a sample with the highest occurrence frequency among values of samples neighboring a current sample. Here, a neighboring sample may include at least one of a left neighboring sample, a right neighboring sample, a bottom neighboring sample, a top neighboring sample, a top-left neighboring sample, a top-right neighboring sample, a bottom-left neighboring sample or a bottom-right neighboring sample of a current sample.

Alternatively, based on a specific sample, a dominant state among occupancy states of samples neighboring a specific sample may be judged and an occupancy state of a specific sample may be corrected to a dominant state.

Meanwhile, when an occupancy state is corrected, a value of a texture pixel corresponding to a depth pixel may be referred to. Accuracy of occupancy state or depth value correction may be improved by referring to a value of a texture pixel. An occupancy state has the same depth and texture, so when there is ambiguity of an occupancy state in a depth pixel, an occupancy state may be corrected by confirming a corresponding texture and confirming that a pixel value of a corresponding region is expressed as 0 or 128 which means there is no texture.

One of the above-described occupancy state correction methods may be used in a fixed way in an encoder and a decoder. Alternatively, after a plurality of occupancy state expressions among the above-described occupancy state expressions are configured as occupancy state correction method candidates, one of a plurality of occupancy state correction method candidates may be selected to correct an occupancy state. In an example, occupancy state correction method candidates may include at least one of a method of using a dominant state, a method of using a central value filter, a method of using an average value filter or a method of using the most probable value.

The above-described occupancy state correction may be performed only when a value of a pixel is similar to a threshold value for judging an occupancy state (hereinafter, a first threshold value). In other words, only when a difference between a value of a pixel and a first threshold value does not exceed a second threshold value, correction for at least one of an occupancy state or a value of a pixel may be performed.

In addition, correction of an occupancy state or a value of a pixel may be performed before scaling a depth atlas or may be performed after scaling a depth atlas.

In order to correct an occupancy state in a unit of a block, influence of error pixels in a specific block should not be dominant. In order to check it out, under Common Test Conditions (CTC) of MIV, when an atlas was encoded by the highest quantization parameter, a block with an error in an occupancy state due to an encoding error was empirically observed. In addition, the number of blocks that error correction for an occupancy state may not be performed according to a proposed method was also observed. Here, a block that error correction may not be performed indicates a block that a result derived from error correction is inaccurate.

FIG. 7 represents the number of blocks that an error per sequence occurs and the number of blocks that correction may not be performed by a proposed error correction method according to a value of threshold value T.

As a value of threshold value T is smaller, an error in an occupancy state occurs more easily, so it may be seen that the number of error blocks increases, and the number of blocks which may not be corrected by a proposed method also increases. But, it was confirmed that although a value of T decreases, an occupancy state error for most blocks may be corrected by a proposed method.

Guard band T may not be used for depth expression. Accordingly, if guard band T is lowered, a depth dynamic scope may be widened to improve rendering quality and end-to-end coding performance. When a proposed depth correction method is applied, a value of guard band T may be adjusted to be smaller than a traditional one. More accurate depth expression is possible by reducing guard band T and expanding a depth dynamic scope, improving rendering quality.

Meanwhile, according to a content type, whether to apply an occupancy state correction method described in the present disclosure may be adaptively determined. In an example, for a computer graphic (CG) type of content, an occupancy state correction method described in the present disclosure is applied, whereas for a non-computer graphic (NC) type of content, an occupancy state correction method described in the present disclosure may not be applied.

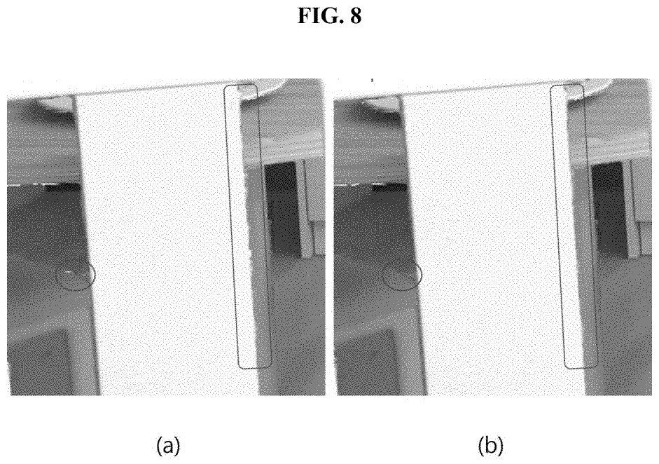

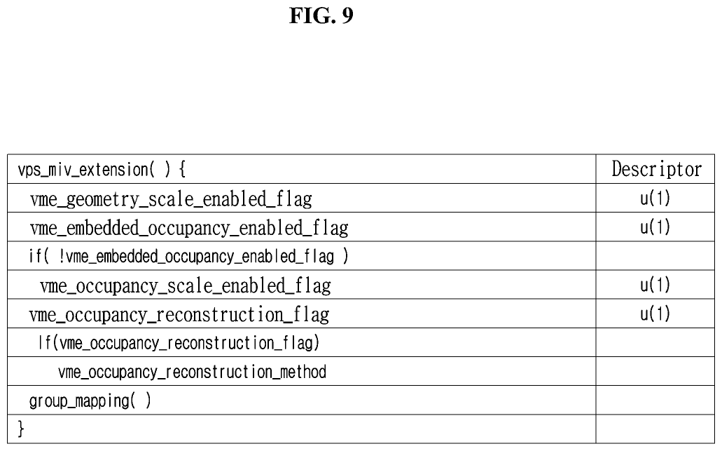

FIG. 8 compares a viewport image according to whether an occupancy state correction method is applied.

A. of FIG. 8 is a viewport image when an occupancy state correction method is not applied and (b) of FIG. 8 is a viewport image when an occupancy state correction method is applied.

Comparing a box area in FIG. 8, an occupancy state correction method may be applied to confirm that an artifact generated when an occupancy state correction method was not applied was reduced.

Meanwhile, information related to performance of occupancy state correction may be encoded as metadata and signaled.

FIG. 9 represents a syntax structure including information related to occupancy state correction.

In an example shown in FIG. 9, a syntax, vme_occupancy_reconstruction_flag, represents whether an occupancy state correction method is applied. In an example, when a value of a syntax, vme_occupancy_reconstruction_flag, is 1, it represents that an occupancy state correction method is applied and when a value of a syntax, vme_occupancy_reconstruction_flag, is 0, it represents that an occupancy state correction method is not applied.

Meanwhile, whether to allow occupancy state correction may be determined by comparing a size of guard band T with a threshold value. In an example, for at least one of a case in which a size of guard band T is greater than a first threshold value, or a case in which a size of guard band T is smaller than a second threshold value, it may be allowed to correct an occupancy state.

A syntax, vme_occupancy_reconstruction_method, indicates one of a plurality of occupancy state correction method candidates.

Alternatively, according to a size of a depth atlas, a bit depth, or a size of guard band T, one of occupancy state correction method candidates may be adaptively selected.

In order to correct an occupancy state error, a threshold value in an encoder and a decoder may be configured differently.

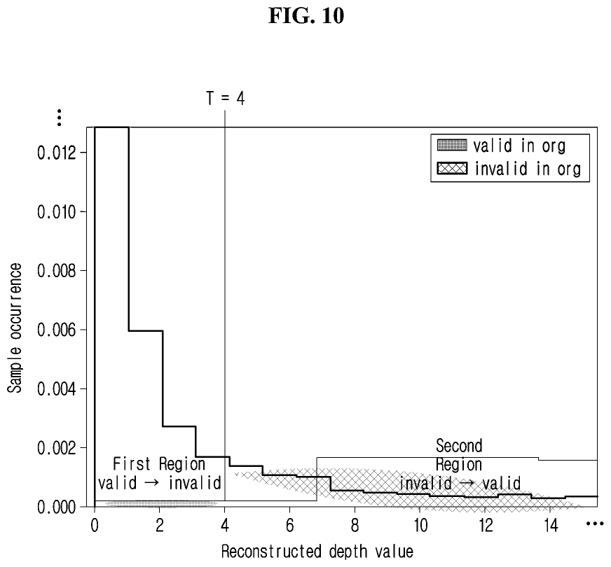

FIG. 10 represents a reconstructed depth value histogram after atlas encoding and decoding.

On a histogram of FIG. 10, a valid pixel and invalid pixel judgment error is shown.

In principle, in an encoder and a decoder, a threshold value for judging a valid pixel and an invalid pixel may be configured equal. In an example, when threshold value T in an encoder is configured as 4, threshold value T may be also configured as 4 in a decoder.

But, an error in valid/invalid judgment may occur due to a reconstruction error, and in this case, as in an example shown in FIG. 10, a case in which an error occurs in a reconstructed depth value and an original valid pixel is judged as an invalid pixel occurs more frequently than a case in which an error occurs in a reconstructed depth value and an original invalid pixel is judged as a valid pixel.

Considering it, when a threshold value greater than a threshold value in an encoder is used in a decoder, a judgment error in an occupied pixel may be further reduced.

Meanwhile, in an encoder, a threshold value used in an encoder may be encoded and signaled. In this case, in a decoder, according to image characteristics, a threshold value may be modified by multiplying a decoded threshold value by N or by adding an offset to a decoded threshold value. Here, N may be a real number equal to or greater than 1.

Alternatively, an offset for modifying a threshold value may be explicitly encoded and signaled.

Alternatively, instead of a threshold value used in an encoder, a threshold value used in a decoder may be encoded and signaled.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. An immersive image encoding method comprising:
classifying a plurality of view images into a basic image and an additional image;
performing pruning for at least one of the plurality of view images based on the classification result;
generating a depth atlas based on a result of performing the pruning; and
correcting an occupancy state of pixels in the depth atlas.

2. The method according to claim 1, wherein:
based on a dominant state in a block, the correction is performed,
the dominant state is determined by comparing a number of valid pixels with the number of invalid pixels in the block.

3. The method according to claim 1, wherein:
the correction is performed by applying a central value filter in a block.

4. The method according to claim 1, wherein:
the correction is performed by applying an average filter in a block.

5. The method according to claim 1, wherein:
the correction is a change of a value of the current pixel into one of the most probable values around the current pixel.

6. The method according to claim 1, wherein:
the correction is performed based on one of a plurality of correction method candidates,
information indicating one of the plurality of correction method candidates is encoded and signaled.

7. The method according to claim 1, wherein:
the occupancy state of the pixel is determined by comparing a pixel value with a first threshold value,
the correction is performed only when a difference between the pixel value and the first threshold value is smaller than a second threshold value.

8. An immersive image decoding method comprising:
receiving a bitstream;
decoding a depth atlas from the bitstream; and
correcting an occupancy state of pixels in the depth atlas.

9. The method according to claim 8, wherein:
based on a dominant state in a block, the correction is performed,
the dominant sate is determined by comparing a number of valid pixels with the number of invalid pixels in the block.

10. The method according to claim 8, wherein:
the correction is performed by applying a central value filter in a block.

11. The method according to claim 8, wherein:
the correction is performed by applying an average filter in a block.

12. The method according to claim 8, wherein:
the correction is a change of a value of the current pixel into one of the most probable values around the current pixel.

13. The method according to claim 8, wherein:
the correction is performed based on one of a plurality of correction method candidates,
one of the plurality of correction method candidates is selected based on information decoded from the bitstream.

14. The method according to claim 8, wherein:
the occupancy state of the pixel is determined by comparing a pixel value with a first threshold value,
the correction is performed only when a difference between the pixel value and the first threshold value is smaller than a second threshold value.

15. A computer-readable recording medium recording an immersive image encoding method comprising:
classifying a plurality of view images into a basic image and an additional image;
performing pruning for at least one of the plurality of view images based on the classification result;
generating a depth atlas based on a result of performing the pruning; and
correcting an occupancy state of pixels in the depth atlas.
